(19) United States
(12) Patent Application Publication
(10) Pub. No.: US 2013/0054658 A1
(43) Pub. Date: Feb. 28, 2013

(54) VIRTUAL FILE DIRECTORY SERVICES FOR MOBILE DEVICES

(71) Applicants: Seraphin B. Calo, Cortlandt Manor, NY (US); Maroun Touma, Redding, CT (US); Dinesh C. Verma, New Castle, NY (US)

(72) Inventors: Seraphin B. Calo, Cortlandt Manor, NY (US); Maroun Touma, Redding, CT (US); Dinesh C. Verma, New Castle, NY (US)

(73) Assignee: INTERNATIONAL BUSINESS MACHINES CORPORATION, Armonk, NY (US)

(21) Appl. No.: 13/221,345

(22) Filed: Aug. 30, 2011

(51) Int. Cl. G06F 17/30

(52) U.S. Cl. 707/827; 707/E17.005; 707/E17.01

(57) ABSTRACT

Establishing virtual file directory services by receiving a notification from a first device in a first zone is that the first device is sharing a resource. Information about the shared resource is stored in an index. The stored information indicates that the resource is available from the device. As the device enters a second zone the stored information is transmitted to the second zone from the first zone.

### BACKGROUND

This invention relates generally to processing within a computing environment, and more particularly to establishing and maintaining file directory services for mobile devices.

With the great increase in data traffic due to the proliferation of computing devices and smartphones communications carriers have a shortage of bandwidth in their backhaul or core networks. Peer-to-Peer (P2P) networks for exchanging files between distributed users can generate large amounts of traffic, especially as their use on mobile devices increases. By redirecting file requests in P2P networks from the core wireless network to the edge of the carrier network, bandwidth requirements on the core portion of the network are decreased.

P2P network protocols have two stages. The first deals with finding the desired information, is time consuming, and often requires a large number of connections to various file servants on the network in order to locate the desired information, and as a result, may fail to yield positive results in a mobile network as devices move from one zone to another in the wireless network. The second deals with the transmission of that information to the requesting party. Since files, particularly media files, can be quite large, the second stage typically consumes more bandwidth than the first. When a file is located and the requesting device sends a message (e.g., HTTP GET) to the device that has a copy of the file (the target device), the address of the target device needs to be resolved by a DNS server in the core network. Once the address of the target system is resolved to an Internet protocol (IP) address, the request is routed over the core network to the second device, and the file transfer is initiated over the core network. The file transfer directly impacts the traffic over the core network even if the target system is sharing the same edge network equipment as the requestor.

### BRIEF SUMMARY

An embodiment includes a computer implemented method for establishing virtual file directory services. The method includes receiving a notification from a first device in a first zone that is sharing a resource. The method additionally includes storing information about the shared resource in an index. The stored information indicates that the resource is available from the device. The method additionally includes determining, by the computer, that the device is entering a second zone, and transmitting the stored information to the second zone based on that determination.

An additional embodiment includes a system for establishing virtual file directory services. The system comprises a file directory proxy computer configured to receive a notification from a device in a first zone that the device is sharing a resource. The file directory proxy additionally stores information about the shared resource in an index, the stored information indicating that the resource is available from the device. The file directory proxy computer additionally determines that the device is entering a second zone, and transmits the stored information to the second zone in response to determining that the device has entered the second zone.

A further embodiment includes a computer program product for establishing virtual file directory services. The computer program product comprising a tangible storage medium readable by a processing circuit and storing instructions for execution by the processing circuit for performing a method. The method includes receiving a notification from a first device in a first zone that is sharing a resource. The method additionally includes storing information about the shared resource in an index. The stored information indicates that the resource is available from the device. The method additionally includes determining, by the computer, that the device is entering a second zone, and transmitting the stored information to the second zone based on that determination.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

Referring now to the drawings wherein like elements are numbered alike in the several FIGURES:

FIG. 1 depicts a schematic diagram of a system for virtual file directory services in a mobile network that may be implemented by an embodiment;

FIG. 2 depicts a schematic diagram of a system for virtual file directory services for mobile devices;

FIG. 3 depicts a schematic diagram of a multi-zone radio access network in an embodiment;

FIG. 4 depicts a schematic diagram of a multi-zone radio access network with transitioning client handsets in an embodiment;

FIG. 5 depicts a flow diagram of the registering of a shared resource in an index file in an embodiment; and

FIG. 6 depicts a flow diagram of the transferring of index file information during a transition of a handset from a first zone to a second zone in an embodiment.

### DETAILED DESCRIPTION

An embodiment of the present invention provides for creating a virtual network directory for a mobile device network.

In an embodiment, a wireless network maintains a list of resources that are shared among mobile devices. The list includes the number of devices that are sharing the resources, and contains an association between the resources and the handset or handsets that are sharing the resource.

In an embodiment, as the mobile device moves between zones, the resource sharing information is passed to the next zone, which eliminates the need to discover the shared resources as new devices enter a zone. When the device exits a zone the resource sharing information is updated to reflect that the mobile device is no longer available within that zone.

Often a shared resource (i.e. music files) to be copied multiple times. In a P2P network of mobile devices, the mobile device where the shared resource was first introduced into the radio access network is a primary host. A mobile device that has obtained a copy of the shared resource as a secondary host. The primary host may become unreachable as it moves from one radio access network to the next, or when it enters a roaming mode. There is currently no mechanism in place within the radio access network to allow an authorized user to locate the secondary host when the primary host for the resource is unreachable.

Current solutions for file directories structures and P2P Networks rely on the persistence and availability of the data at “specific” locations within the network. Mobile devices, on the other hand, are often moving from one radio access network to the next. While current solutions are unable to cope with constantly changing locations, it also fails to take advantage of the fact that, by moving from one radio access network to the next, shared resources can spread across multiple geographies and become available over a wider area of coverage.

In an embodiment, a resource tracked through an indexing scheme, may be a file such as a music file or video or e-book, in addition to more complex assets, such as a vehicle or other expensive equipment that an organization needs to track.

A zone in a mobile network may refer to the area of coverage of a tower, a radio network controller (RNC) or any other partition the wireless carrier uses to identify the edge of the network. In an embodiment, within each zone, an index file is maintained of all the resources available on the devices that are within the area of coverage of the radio access network. This includes an index of the resources that the owner of the wireless network may have stored on select devices as well as the index for shared resources (i.e. pictures, recording, encrypted records, device configuration, etc.) that the device owner has decided to share with, other or has obtained from, other devices.

In an embodiment, when a device has a resource, the device may announce it via a message, using e.g., SMS or a peer-to-peer (P2P) protocol, to a published identifier, or may use a crawler provided by the wireless career in order to make a first entry of the reference to the resource into a resource directory for the device's coverage area. When a second device obtains a copy of a resource from the host device, the number of references to the given resource in the resource directory is incremented by one and the unique id of second device (i.e., the mobile equipment identifier (MEID), IP address, etc.) of the second device is associated with the named resource (i.e., the file) in the directory.

In an embodiment, when the host device travels from a first zone into a second zone, the number of references to a resource in the first zone is decreased by 1 and a new entry for the resource on the host device is created in the host device's new zone, or if a reference to the resource already exists in the new zone, the reference count for the resource in the new zone is incremented by 1. As the host device travels between the first zone and the second zone there will be a period where the host device is ‘present’ in both zones. This is due to the overlap in areas of coverage. This overlap period allows the resource directories for both the first zone and the second zone to negotiate the transfer of the resource from one resource directory to the next.

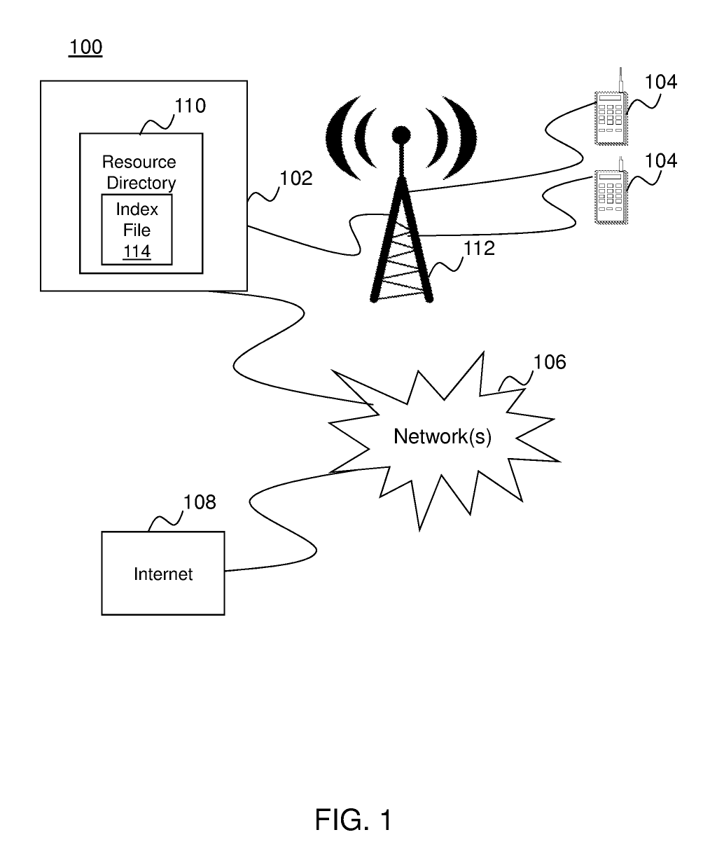

Turning now to FIG. 1, a system 100 for virtual file directory services for mobile devices in an embodiment. In an embodiment, the system 100 includes a host system computer 102 executing computer instructions for virtual file directory services for mobile devices. The host system computer 102 may operate in any type of environment that is capable of executing a software application. The host system computer 102 may comprise a high-speed computer-processing device, such as a mainframe computer, to manage the volume of operations governed by an entity for which the system for virtual file directory services is executing. In an embodiment, the host system computer 102 is part of an enterprise (e.g., a commercial business) that implements the system for providing virtual file directory services for mobile devices. In an additional embodiment, the host system computer 102 is a hardware or software component executing directly at a radio access network, such as the radio access network 112. In an embodiment, the host system computer 102 operates as an edge proxy server.

In an embodiment, the system 100 depicted in FIG. 1 includes one or more client handsets 104 through which users at one or more geographic locations may contact the host system computer 102 or each other. The one or more client handsets 104 are coupled to the host system computer 102 through a radio access network 112. In an embodiment, the file directory proxy server is executed directly on the radio access network 112. Each of the one or more client handsets 104 may be implemented using a general-purpose computer executing a computer program for carrying out the processes described herein such as a mobile phone or a smart phone. In an embodiment, the one or more client handsets 104 are capable of Internet connectivity, and are capable of the execution of software thereon. The one or more client handsets 104 connect to the radio access network 112. In an embodiment, the one or more client handsets 104 are mobile telephone handsets, and in an embodiment, the one or more client handsets 104 move between one or more radio access networks 112 as is known in the art.

In an embodiment, the host system computer 102 is a file directory proxy server in communication with the radio access network 112. In an embodiment, the host system computer 102 executes on or within the radio access network 112. In an embodiment the host system computer 102 includes a resource directory 110. The resource directory 110 includes an index file 114. The index file 114 includes a list of the resources available on the handsets attached to the radio access network 112. In a further embodiment, the index file 114 additionally includes a count of how many handsets are sharing that resource, and/or the associated ID's of the handsets that are sharing that resource. In an embodiment, the resource directory 110 is a hardware device included in the host system computer 102. In an additional embodiment, the resource directory 110 is a hardware device included in the radio access network 112. In yet another embodiment, the resource directory 110 is software executing on the host system computer 102 and/or the radio access network 112. In an embodiment, the host system computer 102 is in communication to one or more networks 106. The one or more networks 106 may be any type of known network including, but not limited to, a wide area network (WAN), a local area network (LAN), a global network (e.g., Internet), a virtual private network (VPN), and an intranet. The networks 106 may be implemented using a wireless network or any kind of physical network implementation known in the art. The host system computer 102 is communication with the Internet 108 over the network 106.

It will be understood that the redirecting of file traffic from a core server to the network edge system described in FIG. 1 may be implemented in hardware, software executing on a general-purpose computer, or a combination thereof.

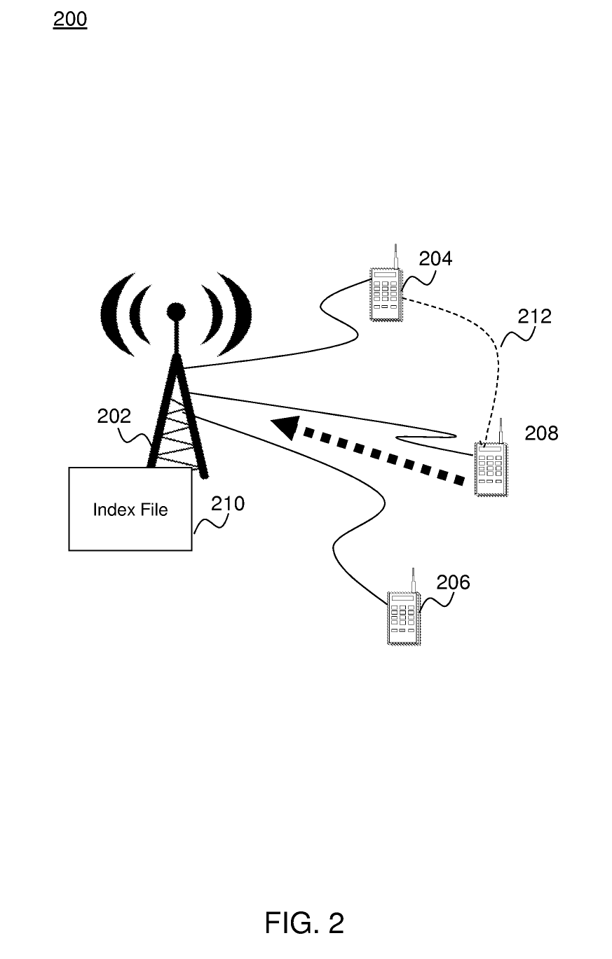

FIG. 2 depicts a schematic diagram of a system 200 for virtual file directory services for mobile devices. In an embodiment, the system 200 includes a radio access network 202. The radio access network 202 includes an index file 210 and one or more client handsets 204, 206, and 208. The radio access network 202 includes a radio tower, communication equipment and network equipment as is known in the art. The radio access network 202 allows each of a plurality of handsets to communicate both telephonically and over a network. In an embodiment, the radio access network 202 enables the client handsets 204, 208 and 206 to communicate over a core network, such as the Internet. The radio access network 202 supports communication for a set of client handsets 204, 206, and 208 in a particular geographic area called a zone. As client handsets, such as client handset 208 enter the radio access network's 202 zone, the client handset 208 is seamlessly passed to the radio access network 202 from a separate zone. In an embodiment, each of the client handsets 204, 206 and 208, are connected to the radio access network 202 and are therefore part of the radio access network's zone. In an embodiment, each of the client handsets 204, 206 and 208 execute file-sharing software, such as peer-to-peer (P2P) software. In an embodiment, the client handset 208 executes the P2P software and notifies the radio access network 202 that it is sharing one or more resources. The identifiers of the one or more resources are stored in the index file 210. In an embodiment, one or more of the one or more resources is already in the index file 210, and a counter associated with the resource file entry is updated to indicate that an additional device is sharing that resource. A unique identifier of the handset is stored within the index file 210 to associate the resource with the handset that is sharing it.

In an embodiment, a second handset 204 requests the file from the handset 208 and begins to receive a copy of the file 212. The radio access network tracks the beginning, and successful completion of the file copy operation and updates the index file 210 to include the second handset 204 as an additional source for that resource.

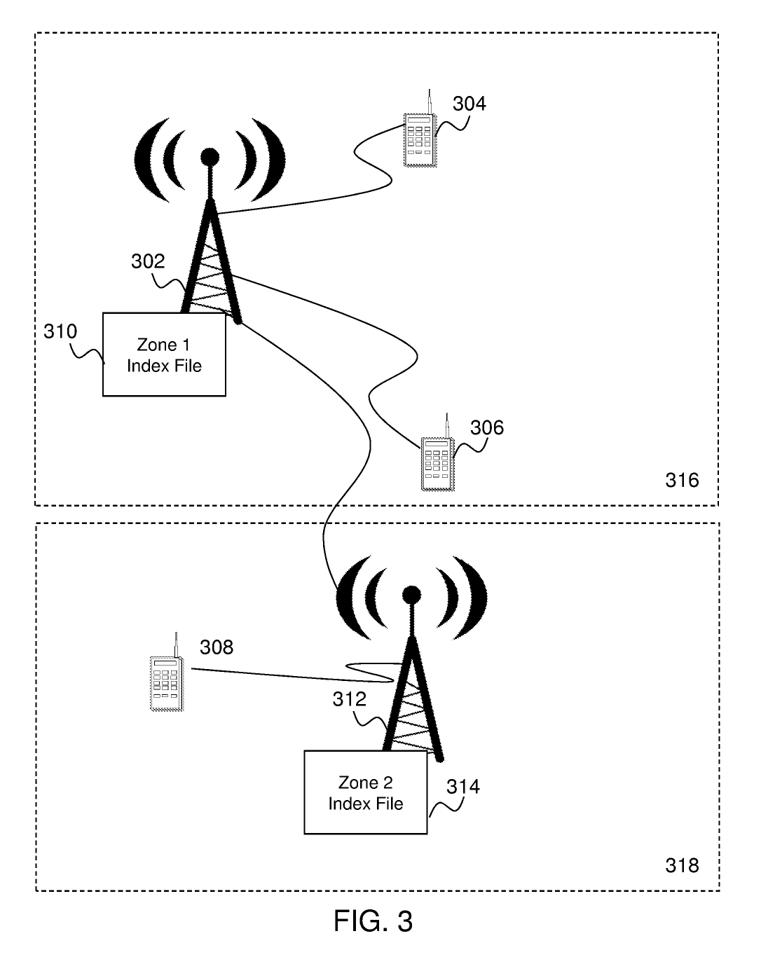

FIG. 3 depicts a schematic diagram of a multi-zone radio access network in an embodiment. In an embodiment, the multi-zone radio access network includes zone one 316. Zone one 316 includes a zone one radio access network 302. The zone one radio access network 302 includes a zone one index file 310. The zone one index file 310 includes information about resources that are being shared by devices within the zone one 316, such as device one 304 and device two 306. The zone one radio access network 302 is in communication with a zone two radio access network 312. The zone two radio access network 312 is within zone two 318. The zone two radio access network 312 includes a zone two index file 314. The zone two index file 314 includes information about resources that are being shared by devices within the zone one 318, such as device three 308. In an embodiment, zone one 316 and zone two 318 occupy different geographical areas. In an additional embodiment, the zone one 316 and zone two 318 occupy overlapping geographic regions. Each of device one 304, device two 306 and device three 308 may move between either of the zones and are transferred to the radio access network within the new zone as will be described in more detail below.

FIG. 3 depicts a limited number of radio access networks and handsets for purposes of clarity. It will be understood that in additional embodiments any number of zones, radio access networks, and client handsets may be supported.

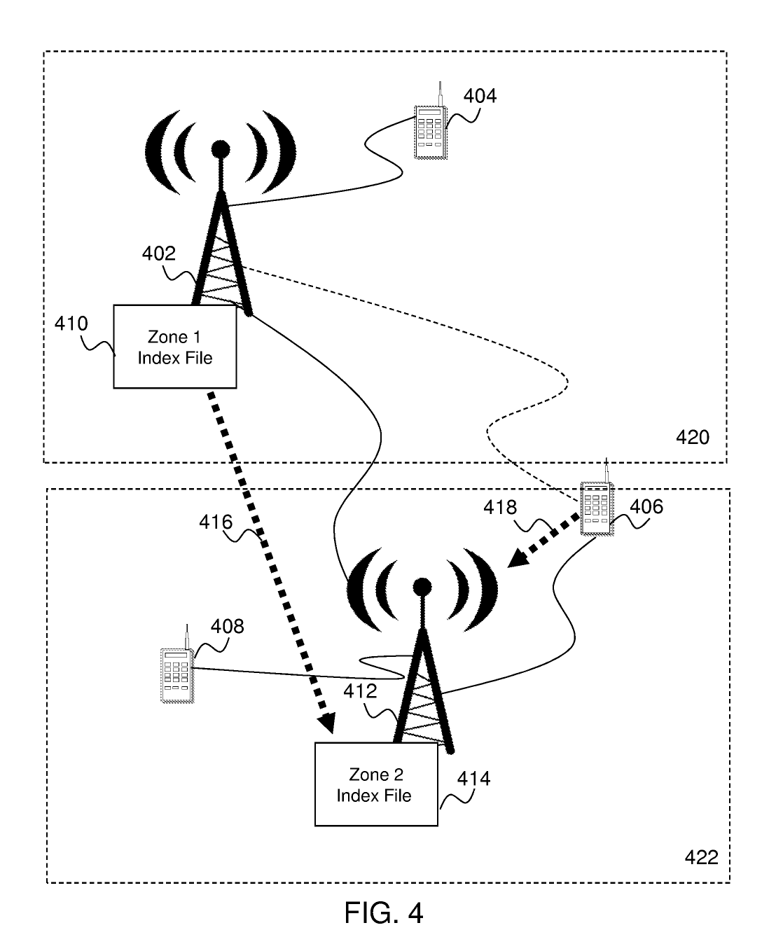

FIG. 4 depicts a schematic diagram of a multi-zone radio access network with transitioning client handsets in an embodiment. In an embodiment, the multi-zone radio access network of FIG. 4 includes a zone one 420 and a zone two 422. The zone one 420 includes a zone one radio access network 402. The zone one radio access network 402 includes a zone one index file 410 as described above. The zone two 422 includes a zone two radio access network 412. The zone two radio access network 412 includes a zone two index file 414. The zone one radio access network 402 is in communication with the zone two radio access network 412. In an embodiment, the zone one radio access network 402 is in communication with a first client handset 404 and a second client handset 406. In an embodiment the zone two radio access network 412 is in communication with a third client handset 408.

In an embodiment, the second client handset 406 transitions from the zone one 420 to the zone two 422. As the second client handset 406 enters the zone two 422, it makes a handshake 418 with the zone two radio access network 412 and is seamlessly passed from the zone one radio access network 402 to the zone two radio access network 412. In an embodiment, as the second client handset 406 is passed to the zone two radio access network 412, the shared resource information associated with the second client handset 406 in the zone one index file 410 is transferred to the zone two index file 414 using a transfer operation 416. In an embodiment, zone one 420 and zone two 422 occupy different geographical areas. In an additional embodiment, the zone one 420 and zone two 422 occupy overlapping geographic regions. Each of the one or more client handsets 404, 406 and 408 may move between either of the zones and are transferred to the radio access network with the new zone as will be described in more detail below.

FIG. 4 depicts a limited number of radio access networks and handsets for purposes of clarity. It will be understood that in additional embodiments any number of zones, radio access networks, and client handsets may be supported.

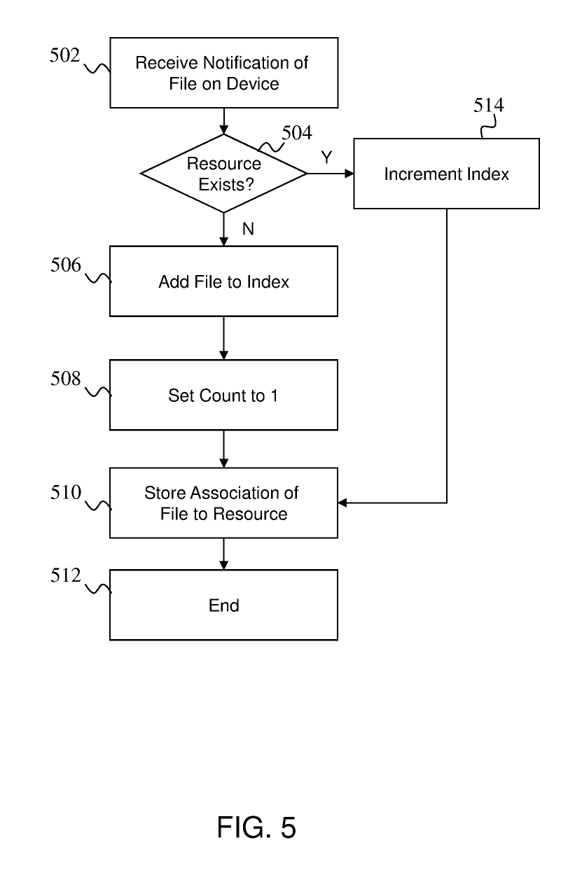

FIG. 5 depicts a flow diagram of the registering of a shared resource in an index file in an embodiment. In an embodiment, the process flow of FIG. 5 is executed by a computer processor executing on a resource directory, which is in turn executing on a radio access network such as the radio access network 112 of FIG. 1. At block 502, a notification is received from a device within the zone serviced by the radio access network 112 indicating that the device has a resource to share. At block 504, it is determined if a reference to the resource exists in the index file. If a reference to the resources does not exist in the index file, then at block 506 a description, and/or unique identifier of the resource is added to the index file. At block 508, a counter is set to 1 to indicate that one device within the zone is sharing the file. At block 510, an association is set between the resource and the device. In an embodiment, the association made by storing a record of a unique identifier of the device along with the unique identifier of the resource. Processing ends at block 512.

Returning to block 504, if the resource already exists in the index, i.e., another device is already sharing the same resource then, at block 514, the counter associated with the resource is incremented to indicate that an additional device is sharing the resource. Processing continues at block 510, where an association is set between the resource and the device. In an embodiment, the association made by storing a record of a unique identifier of the device along with the unique identifier of the resource. Processing ends at block 512.

Although the process flow of FIG. 5 includes the sharing of only a single resource from a device, it will be understood that in additional embodiments a device may share any number of resources by executing the process flow either sequentially for each resource, or in parallel for all resources.

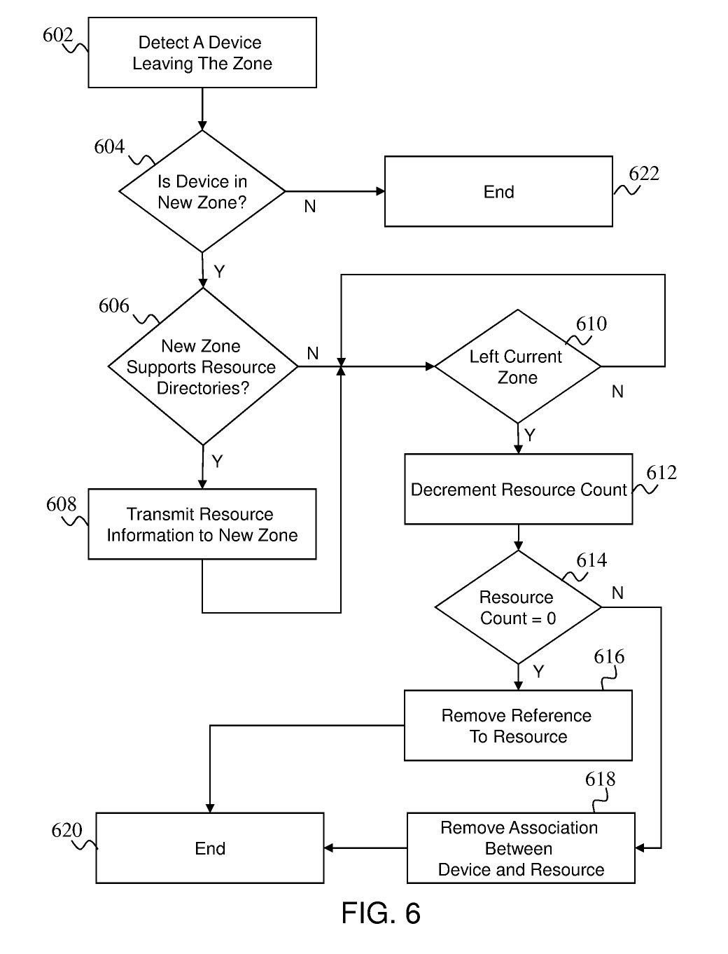

FIG. 6 depicts a flow diagram of the transferring of index file information during a transition of a handset from a first zone to a second zone in an embodiment. In an embodiment the process flow of FIG. 6 is executed by a resource directory executing on a radio access network such as the radio access network 112 of FIG. 1. At block 602, the radio access network detects that a client handset is transferring out of its zone to a second zone. At block 604, it is determined if the client handset has successfully moved to the new zone. If the move was not successful, i.e., the client handset dropped from the network, processing ends at block 612.

Otherwise, if the transfer was successful, at block 606 it is determined if the new zone includes a resource directory and an index file. If the new zone includes a resource directory, then at block 608, the information stored in the index file related to that handset is transferred to the new zone and added to the index file in the new zone. At block 610, it is determined if the handset has left the current zone. As a handset transfers to a new zone, the handset will maintain a connection to both the old zone and the new zone for a period of time. If the handset is still in the first zone, then the processing waits until the handset has left the first zone. Otherwise, if the handset has left the first zone, then at block 612, the resource counter in the index file of the first zone is decremented. At block 614, the counter is check to determine if it is now zero. If the count is not zero, then at block 618, the association between the exiting device and the resource is removed from the index file, and processing ends at block 620. Otherwise, if the counter is 0, then the reference to the resource is removed from the index file all together, at block 616, and processing ends at block 620.

Technical effects and benefits include is the ability to track which devices are sharing a resource within a zone. An additional benefit the ability to transfer information about which resources are available from a device, even as that device transitions from zone to zone.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible storage medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or schematic diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As described above, embodiments can be embodied in the form of computer-implemented processes and apparatuses for practicing those processes. In embodiments, the invention is embodied in computer program code executed by one or more network elements. Embodiments include a computer program product on a computer usable medium with computer program code logic containing instructions embodied in tangible media as an article of manufacture. Exemplary articles of manufacture for computer usable medium may include floppy diskettes, CD-ROMs, hard drives, universal serial bus (USB) flash drives, or any other computer-readable storage medium, wherein, when the computer program code logic is loaded into and executed by a computer, the computer becomes an apparatus for practicing the invention. Embodiments include computer program code logic, for example, whether stored in a storage medium, loaded into and/or executed by a computer, or transmitted over some transmission medium, such as over electrical wiring or cabling, through fiber optics, or via electromagnetic radiation, wherein, when the computer program code logic is loaded into and executed by a computer, the computer becomes an apparatus for practicing the invention. When implemented on a general-purpose microprocessor, the computer program code logic segments configure the microprocessor to create specific logic circuits.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer implemented method for establishing virtual file directory services, the method comprising:
receiving, by a computer, a notification from a device in a first zone that the device is sharing a resource;
storing, by the computer, information about the shared resource in an index, the stored information indicating that the resource is available from the device;
determining, by the computer, that the device is entering a second zone; and
responsive to determining that the device is entering the second zone, transmitting the stored information to the second zone.

2. The computer implemented method of claim 1, wherein the stored information includes a unique identifier of each of one or more devices that are sharing the resource, and a unique identifier of the resource.

3. The computer implemented method of claim 2, wherein the stored information further comprises a counter indicating a number of devices within the first zone that are sharing the resource.

4. The computer implemented method of claim 1, further comprising:
determining if another device is sharing the same resource, responsive to receiving the notification;
wherein, the storing comprises creating an entry in the index to indicate that the resource is now available, responsive to determining that the resource is not being shared by another device, and the storing comprises updating the entry in the index to indicate that the resource is available from another device.

5. The computer implemented method of claim 3, further comprising:
determining that the device has left the first zone; and
responsive to determining that the device has left the first zone, decrementing the counter, and removing the unique identifier of the device from the stored information.

6. The computer implemented method of claim 5, wherein if the counter is zero, all of the stored information related to the resource is removed from the index.

7. The computer implemented method of claim 1, wherein the second zone receives the transmitted stored information, and updates a second zone index to include the transmitted stored information.

8. The computer implemented method of claim 1, wherein the device is a mobile handset.

9. A system for establishing virtual file directory services, the system comprising:
a file directory proxy computer configured to:
receive a notification from a device in a first zone that the device is sharing a resource;
store information about the shared resource in an index, the stored information indicating that the resource is available from the device;
determine that the device is entering a second zone; and
responsive to determining that the device is entering the second zone, transmit the stored information to the second zone.

10. The system of claim 9, wherein the stored information includes a unique identifier of each of one or more devices that are sharing the resource, and a unique identifier of the resource.

11. The system of claim 10, wherein the stored information further comprises a counter indicating a number of devices within the first zone that are sharing the resource.

12. The system of claim 9, further comprising:
determining if another device is sharing the same resource, responsive to receiving the notification;
wherein, the storing comprises creating an entry in the index to indicate that the resource is now available, responsive to determining that the resource is not being shared by another device, and the storing comprises updating the entry in the index to indicate that the resource is available from another device.

13. The system of claim 11, further comprising:
determining that the device has left the first zone; and
responsive to determining that the device has left the first zone, decrementing the counter, and removing the unique identifier of the device from the stored information.

14. The system of claim 13, wherein if the counter is zero, all of the stored information related to the resource is removed from the index.

15. The system of claim 9, wherein the second zone receives the transmitted stored information, and updates a second zone index to include the transmitted stored information.

16. The system of claim 9, wherein the device is a mobile handset.

17. A computer program product for establishing virtual file directory services, the computer program product comprising:
a tangible storage medium readable by a processing circuit and storing instructions for execution by the processing circuit for performing a method comprising:
receiving a notification from a device in a first zone that the device is sharing a resource;
storing information about the shared resource in an index, the stored information indicating that the resource is available from the device;
determining that the device is entering a second zone; and
responsive to determining that the device is entering the second zone, transmitting the stored information to the second zone.

18. The computer program product of claim 17, wherein the stored information includes a unique identifier of each of one or more devices that are sharing the resource, and a unique identifier of the resource.

19. The computer program product of claim 18, wherein the stored information further comprises a counter indicating a number of devices within the first zone that are sharing the resource.

20. The computer program product of claim 17, further comprising:
determining if another device is sharing the same resource, responsive to receiving the notification;
wherein, the storing comprises creating an entry in the index to indicate that the resource is now available, responsive to determining that the resource is not being shared by another device, and the storing comprises updating the entry in the index to indicate that the resource is available from another device.

21. The computer program product of claim 19, further comprising:
determining that the device has left the first zone; and
responsive to determining that the device has left the first zone, decrementing the counter, and removing the unique identifier of the device from the stored information.

22. The computer program product of claim 21, wherein if the counter is zero, all of the stored information related to the resource is removed from the index.

23. The computer program product of claim 17, wherein the second zone receives the transmitted stored information, and updates a second zone index to include the transmitted stored information.

24. The computer program product of claim 17, wherein the device is a mobile handset.
